(19) United States
(12) Patent Application Publication
(10) Pub. No.: US 2018/0189884 A1
(43) Pub. Date: Jul. 5, 2018

(54) Earth Invest Score for Interest Rates

(71) Applicant: Cyrus Hale Afshar, Washington, DC (US)

(72) Inventor: Cyrus Hale Afshar, Washington, DC (US)

(21) Appl. No.: 15/396,368

(22) Filed: Dec. 30, 2016

(51) Int. Cl. G06Q 40/06

(52) U.S. Cl. CPC G06Q 40/06

(57) ABSTRACT

A method for determining whether the Federal Funds interest rate (or interest rates) is more likely to rise or fall. A plurality of factor scores, based on a plurality of factors, is determined. An aggregate score, based on a plurality of factor scores, is then determined.

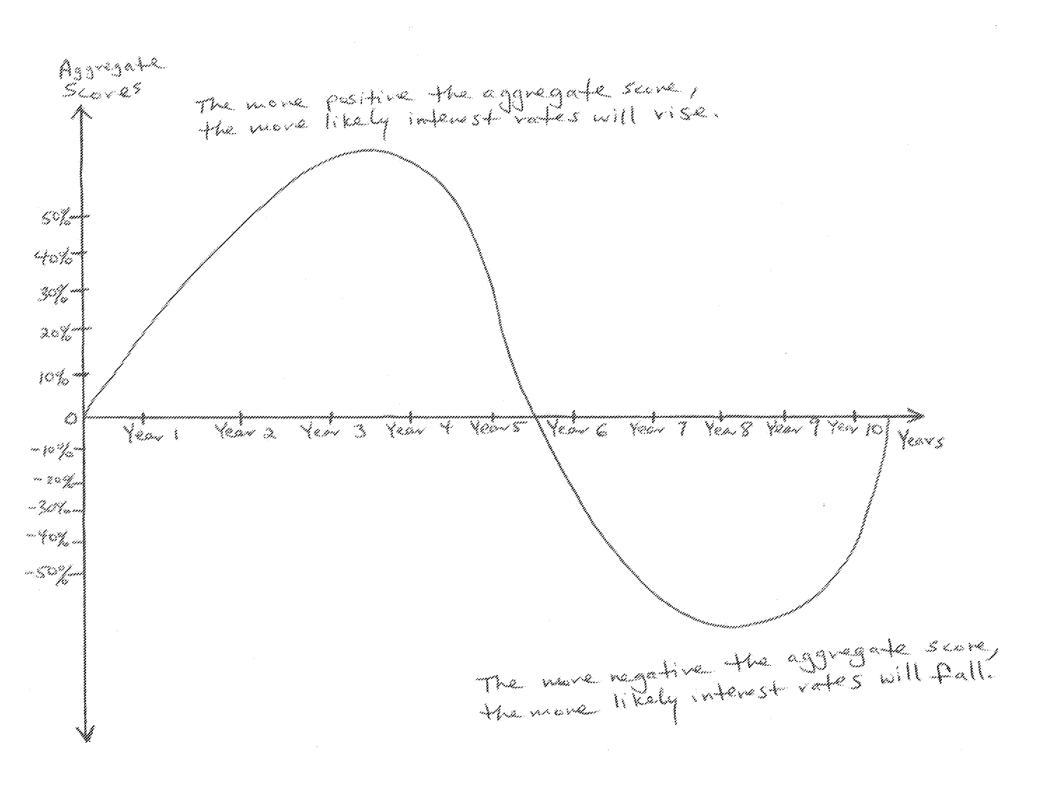

### CROSS-REFERENCE TO RELATED APPLICATIONS

This application claims the benefit of U.S. Provisional Patent Application No. 62/274,149, entitled “Earth Invest Score for Interest Rates,” filed on Dec. 31, 2015.

### BACKGROUND OF THE INVENTION

This invention pertains to investing and most likely belongs in one of the three patent classifications below:

### 1. Class 705, Subclass 35;

### 2. Class 705, Subclass 36; or

### 3. Class 705, Subclass 37.

### BRIEF SUMMARY OF THE INVENTION

Almost all news sources for the Federal Funds interest rate (or interest rates) describe what has already occurred in the market. For example, they'll describe Federal Funds interest rate changes that occurred over the previous day or month or quarter or year. These after-the-fact descriptions are not very useful.

The purpose of this invention is to create an aggregate score of useful forward-looking Federal Funds interest rates information.

This invention uses time-tested value investing principles to help identify whether Federal Funds interest rates are more likely to rise or fall. Value investing is based on the notion that there is a long term fundamental value for every investment. In the short term, the market overreacts to good news and bad news, but in the long term, every investment returns to its fundamental value.

This invention helps to identify the long term fundamental value of the Federal Funds interest rate by using a ratio of key market variables. This invention compares the current value of this ratio to its historic average to help identify whether Federal Funds interest rates are more likely to rise or fall.

### BRIEF DESCRIPTION OF THE SINGLE VIEW OF THE DRAWING

The drawing portrays exemplary embodiment #1, from the Detailed Description of the Invention, in a graphical form.

The more positive the aggregate score, the more likely interest rates will rise.

The more negative the aggregate score, the more likely interest rates will fall.

### DETAILED DESCRIPTION OF THE INVENTION

Various embodiments of this invention are described below to:

(a) Determine a plurality of factor scores, based on a plurality of factors; and
(b) Determine an aggregate score, based on a plurality of factor scores.
1. In one exemplary embodiment, the following steps are taken:

Step 1: Current Value
(a) Calculate (Consumer Price Index)÷(Unemployment Rate).

Step 2: Historic Value
(a) Calculate the 5-year trailing average (or 5-year projected average or a hybrid of trailing and projected average) of (Consumer Price Index)÷(Unemployment Rate).

Step 3: Historic Value
(a) Calculate the 10-year trailing average (or 10-year projected average or a hybrid of trailing and projected average) of (Consumer Price Index)÷(Unemployment Rate).

Step 4: Factor Score
(a) Calculate the percentage difference between Step 1 (a) and Step 2 (a).
   The percentage difference=(Consumer Price Index)÷(Unemployment Rate) compared to 5-year average factor score.

Step 5: Factor Score
(a) Calculate the percentage difference between Step 1 (a) and Step 3 (a).
   The percentage difference=(Consumer Price Index)÷(Unemployment Rate) compared to 10-year average factor score.

Step 6: Aggregate Score
(a) Calculate the average of Step 4 (a) and Step 5 (a).
   The average of the factor scores=the aggregate score.
   The more positive the aggregate score, the more likely interest rates will rise.
   The more negative the aggregate score, the more likely interest rates will fall.
2. Alternative embodiments to exemplary embodiment #1 include, instead of using 5-year and 10-year trailing averages (or projected averages or a hybrid of trailing and projected averages), using 1-year, 2-year, 3-year, 4-year, 5-year, 6-year, 7-year, 8-year, 9-year, 10-year, 11-year, 12-year, 13-year, 14-year, 15-year, 16-year, 17-year, 18-year, 19-year, 20-year, 21-year, 22-year, 23-year, 24-year, 25-year, 26-year, 27-year, 28-year, 29-year, 30-year, 31-year, 32-year, 33-year, 34-year, 35-year, 36-year, 37-year, 38-year, 39-year, 40-year, 41-year, 42-year, 43-year, 44-year, 45-year, 46-year, 47-year, 48-year, 49-year, 50-year, 51-year, 52-year, 53-year, 54-year, 55-year, 56-year, 57-year, 58-year, 59-year, 60-year, 61-year, 62-year, 63-year, 64-year, 65-year, 66-year, 67-year, 68-year, 69-year, 70-year, 71-year, 72-year, 73-year, 74-year, 75-year, 76-year, 77-year, 78-year, 79-year, 80-year, 81-year, 82-year, 83-year, 84-year, 85-year, 86-year, 87-year, 88-year, 89-year, 90-year, 91-year, 92-year, 93-year, 94-year, 95-year, 96-year, 97-year, 98-year, 99-year, or 100-year trailing averages (or projected averages or a hybrid of trailing and projected averages).
3. Alternative embodiments to exemplary embodiments #1 or #2 include, instead of calculating the average (or mean), calculating the median, mode, variance, or standard deviation.
4. Alternative embodiments to exemplary embodiments #1, #2, or #3 include, instead of calculating the average (or mean), median, mode, variance, or standard deviation, calculating the weighted average (or mean), weighted median, weighted mode, weighted variance, or weighted standard deviation.

While various embodiments of this invention have been described above, it should be understood that they have been presented by way of example only, and not limitation. Thus, the breadth and scope of this invention should not be limited by any of the above-described embodiments.

What is claimed is:

1. A method for determining whether the Federal Funds interest rate (or interest rates) is more likely to rise or fall, comprising:
(a) Determining a plurality of factor scores, based on a plurality of factors; and
(b) Determining an aggregate score, based on a plurality of factor scores.

2. The method of claim 1, wherein determining a plurality of factor scores comprises an algorithm.

3. The method of claim 1, wherein determining an aggregate score comprises another algorithm.

4. The method of claim 1, wherein based on a plurality of factors comprises:
(a) The Federal Funds interest rate (or interest rates) at the local, Metropolitan Statistical Area, county, state, regional, or national level for a given period of time;
(b) Consumer Price Index at the local, Metropolitan Statistical Area, county, state, regional, or national level for a given period of time; and
(c) Unemployment Rate at the local, Metropolitan Statistical Area, county, state, regional, or national level, for a given period of time.

5. The method of claim 1, wherein based on a plurality of factor scores comprises:
The current value and historical value of the ratio below:
(a) (Consumer Price Index)÷(Unemployment Rate).

6. The method of claim 2, wherein an algorithm comprises:
Comparing the current value to the historic value of the ratio below:
(a) (Consumer Price Index)÷(Unemployment Rate).

7. The method of claim 3, wherein another algorithm comprises:
Aggregating the comparison of the current value to the historic value of the ratio below into an aggregate score:
(a) (Consumer Price Index)÷(Unemployment Rate).

8. The method of claim 4, wherein the Federal Funds interest rate (or interest rates) comprises a measure of the Federal Funds interest rate (or interest rates) at the local, Metropolitan Statistical Area, county, state, regional, or national level for a given period of time.

9. The method of claim 4, wherein Consumer Price Index comprises a measure of consumer prices at the local, Metropolitan Statistical Area, county, state, regional, or national level for a given period of time and is often expressed as a consumer price index for the trailing month or quarter or year, or as a projected consumer price index, or as a hybrid of a trailing and projected consumer price index.

10. The method of claim 4, wherein Unemployment Rate comprises a measure of the employable portion of the population at the local, Metropolitan Statistical Area, county, state, regional, or national level, which is seeking employment, but has not been able to find suitable employment, for a given period of time and is often expressed as an unemployment rate for the trailing month or quarter or year, or as a projected unemployment rate, or as a hybrid of a trailing and projected unemployment rate.
